(19) United States
(12) Patent Application Publication
(10) Pub. No.: US 2017/0289773 A1
(43) Pub. Date: Oct. 5, 2017

(54) INTELLIGENT SECURITY SYSTEM

(71) Applicant: SHENZHEN SMART RIDING INTELLIGENCE TECHNOLOGY CO., LTD., Shenzhen (CN)

(72) Inventor: Dandan YANG, Shenzhen (CN)

(21) Appl. No.: 15/507,655

(22) PCT Filed: May 19, 2015
(86) PCT No.: PCT/CN2015/079265

§ 371 Date: Feb. 28, 2017

(30) Foreign Application Priority Data
Oct. 14, 2014 (CN) 201410540878.4

(51) Int. Cl. H04W 4/04; H04M 11/00

(52) U.S. Cl. CPC H04W 4/046; H04M 11/007

(57) ABSTRACT

The present invention provides an intelligent security system, where the system includes an in-vehicle information detection apparatus, a telecommunication server, a smartphone, and an unlocking apparatus, where the in-vehicle information detection apparatus sends collected instant vehicle information to the telecommunication server; the network server sends processed instant vehicle information to the smartphone by using a signal; the smartphone sends mobile phone control signal to the telecommunication server; the telecommunication server sends the mobile phone control signal to the in-vehicle information detection apparatus; the unlocking apparatus sends an unlocking signal to the in-vehicle information detection apparatus; and the smartphone and the unlocking apparatus receive a detection signal of an in-vehicle hardware apparatus. The present invention belongs to the technical field of electronic products. An objective of the present invention is to provide an intelligent security system having a real-time anti-theft function and a function of real-time information sharing after a vehicle is stolen.

### BACKGROUND

### Technical Field

The present invention relates to an intelligent system, and in particular, to an intelligent security system.

### Related Art

An existing sport in-vehicle security system includes various bicycles, electric vehicles, and the like, and a core function of the system is to provide an anti-theft function. The system includes an in-vehicle hardware terminal (including a GPS module, a GSM module, and the like) and binds a mobile phone number of a user. If an event happens, the in-vehicle hardware terminal sends a short message to the bound mobile phone number by using a third party to tell the corresponding event to the user.

The anti-theft function of the existing sport in-vehicle system can provide only information that a vehicle may be stolen, but cannot provide information such as specific location information of the vehicle and a track after the vehicle is stolen; and in addition, it is difficult to identify whether the user is misinformed, so that the user cannot perform a corresponding accurate reaction in time.

As described above, except the anti-theft function, the existing in-vehicle system cannot provide functions such as providing a track, collecting statistics on movements, and in-vehicle system based social networking, such as transmitting sharing and comments on relevant pictures, videos, texts, sound, and the like.

### SUMMARY

An objective of the present invention is to provide an intelligent security system, which can prevent a vehicle from being stolen, and can instantly and accurately provide a motion track after the vehicle is stolen.

An intelligent security system is provided, where the system includes an in-vehicle information detection apparatus, a network server, and a smartphone, where the in-vehicle information detection apparatus includes an information transceiving module, a GPS module, and a microprocessor, where the GPS module sends instant location information to the microprocessor; the microprocessor performs initial processing on the received positioning information and sends the processed information to the transceiving module; the transceiving module sends received external instruction information to the microprocessor; the in-vehicle information detection apparatus sends collected instant vehicle information to the network server; the network server sends processed instant vehicle information to the smartphone by using a signal; the smartphone sends a control signal that is fed back by the mobile phone, to the network server; the network server sends the control signal to the in-vehicle information detection apparatus; the smartphone sends an anti-theft enabling signal to the in-vehicle information detection apparatus; and the smartphone receives a detection signal of the in-vehicle information detection apparatus.

Further, the system has an unlocking apparatus, where the unlocking apparatus sends an unlocking signal to the in-vehicle information detection apparatus, and the unlock apparatus receives the detection signal of the in-vehicle information detection apparatus.

Still further, the unlocking apparatus includes a communications module, an authentication module, and an information exchange module, where the communications module transfers the detection signal to the authentication module; the authentication module performs identity authentication according to the received detection signal and sends an authentication signal to the information exchange module; and the information exchange module converts the received authentication signal to an information exchange signal and transfers the information exchange signal to the communications module.

Further, the communications module is a Bluetooth.

Further, the communications module is a 2.4G module.

Further, there is at least one smartphone.

Beneficial effects of using the foregoing technical solution are:

1. The intelligent security system has an intelligent anti-theft function. If a vehicle is in a stolen state, a user may view a location and a motion track of the vehicle by using the smartphone. In addition, the user may deliver, by using the smartphone, a corresponding disposal measure, for example, an instruction such as applying a brake, misfiring, and even destroying, to the vehicle.

2. To reduce a rate of misinforming a user that a vehicle is stolen, after detecting that a vehicle may be stolen and before reporting an alarm, an in-vehicle hardware apparatus detects whether the user exists within 1 to 10 meters around the vehicle first, and communicates with the unlocking apparatus or the mobile phone by using the communications module such as a Bluetooth. If the in-vehicle hardware apparatus detects that the user exists within 1 to 10 meters around the vehicle, the alarm is not reported, and if not, the alarm is reported. In addition, the user may set, by using the smartphone, to protect or not protect the vehicle from being stolen. In a state in which the vehicle is not protected from being stolen, even the vehicle is moved, no alarm is generated.

3. Tracking a motion track, and collecting statistics on movements and vehicle states may be used for personal movement information gathering of the user.

4. A motion-based social networking function is provided, for example, sharing an instant motion track, sharing information and guide of an instant motion route, as well as sharing pictures, videos, sound, motion diaries, and the like. In addition, the function may also be used for a social platform based such kind of information.

### BRIEF DESCRIPTION OF THE DRAWINGS

FIG. 1 is a structural block diagram of a system according to the present invention;

FIG. 2 is a structural block diagram of an in-vehicle information detection apparatus according to the present invention; and

FIG. 3 is a structural block diagram of an unlocking apparatus according to the present invention.

### DETAILED DESCRIPTION

The following further describes the content of the present invention with reference to the accompanying drawings and preferred specific embodiments of the present invention. The given examples are merely used to explain the present invention, but are not intended to limit the scope of the present invention.

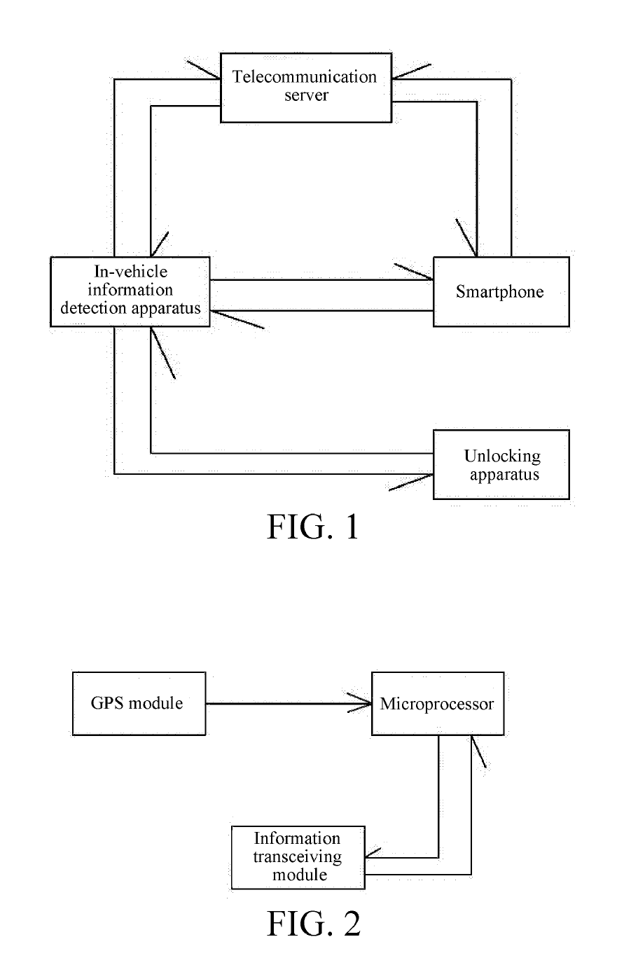

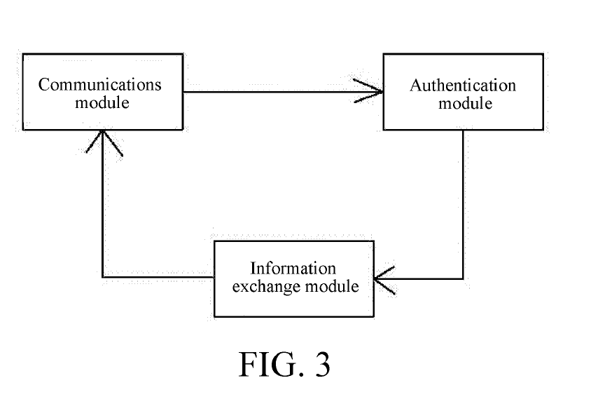

As shown in FIG. 1 to FIG. 3, an intelligent security system is described in this solution, where the system includes an in-vehicle information detection apparatus, a network server, a smartphone, and an unlocking apparatus. The in-vehicle information detection apparatus described in this solution includes an information transceiving module, a GPS module, and a microprocessor, where the GPS module sends instant location information to the microprocessor; the microprocessor performs information integration according to received positioning and sends the integrated information to the transceiving module; and the transceiving module sends received external instruction information to the microprocessor. The in-vehicle information detection apparatus sends collected instant vehicle information to the network server; the network server sends processed instant vehicle information to the smartphone by using a signal; the smartphone sends a mobile phone control signal to the network server; and the network server sends the mobile phone control signal to the in-vehicle information detection apparatus; when a user leaves a vehicle, the smartphone sends an anti-theft enabling signal to the in-vehicle information detection apparatus; the unlocking apparatus sends an unlocking signal to the in-vehicle information detection apparatus; and the smartphone and the unlocking apparatus receive a detection signal of an in-vehicle hardware apparatus. In this solution, there is more than one smartphone. In this solution, the unlocking apparatus includes a communications module, an authentication module, and an information exchange module, where the communications module transfers the detection signal to the authentication module; the authentication module performs identity authentication according to the received detection signal and sends an authentication signal to the information exchange module; and the information exchange module converts the received authentication signal to an information exchange signal and transfers the information exchange signal to the communications module. In this solution, the unlocking apparatus may be a device, such as a hand ring or a product of another structure, having a function of the unlocking apparatus. However, a hand ring is used in this solution. In this solution, the authentication module is configured to: when receiving the detection signal, the authentication module performs authentication and identification according to a built-in system program of a micro central processing chip that is set inside of the authentication module. Further, in this solution, the communications module may be a Bluetooth or may be a 2.4G module, and certainly may be another device having a communications function. However, in this solution, the communications module is a Bluetooth.

During specific implementation, the in-vehicle information detection apparatus sends real-time information of a vehicle to the network server, and the network server receives information from the in-vehicle information detection apparatus, such as location information, a speed, an altitude, a quantity of electricity, and alarm information of the vehicle, where the alarm information includes information indicating that the vehicle is stolen, is hit, is fallen, and the like. After performing initial integration on the received foregoing information of the corresponding vehicle, the network server further sends the integrated information to a smartphone of a user in real-time, receives information fed back by the smartphone at the same time, performs further processing according to an instruction requirement of the smartphone, and then delivers related instruction information to the in-vehicle information detection apparatus. In this solution, except the smartphone used by the user, a smartphone of a second party, a smartphone of a third party, and smartphones of friends of the user that are associated with each other may also be set according to personal information of the user. However, only the mobile phone of the user can finally control the in-vehicle information detection apparatus. However, as a core apparatus of this security system, the in-vehicle information detection apparatus stores the information in sequence at the same time, and perform sharing and social networking based on the information. During a specific operation, the in-vehicle information detection apparatus receives an instruction from the network server and performs a corresponding action. For example, when a vehicle is moved, a Bluetooth is used to detect whether an unlocking apparatus or a smartphone of a user exists within a scope around the vehicle first. If the unlocking apparatus or the smartphone exists, the in-vehicle information detection apparatus does not report an alarm; otherwise, the in-vehicle information detection apparatus reports an alarm. Because an effective transmission distance of the Bluetooth is within 1 to 10 meters, the Bluetooth detects whether the smartphone of the corresponding user exists within 1 to 10 meters around the vehicle first. Specifically, when the smartphone or the unlocking apparatus (such as a hand ring) of the user is within 5 meters around the in-vehicle information detection apparatus, a misinforming effect achieves the best. In this solution, if an emergency occurs when a user drives a vehicle, for example, when the vehicle is hit or is fallen during the driving, the in-vehicle information detection apparatus sends information in real-time or directly calls a friend of the user to early warn or inform the friend of the emergency. In this solution, users may also upload their diaries, pictures, videos, sound, experiences, and guides by using the smartphone, and sharing them with friends in real-time. In addition, a user may also share real-time location information. For example, it is convenient for a third party to monitor location information and a track of a vehicle, for example, parents concern about their child's safety. Moreover, users may upload their social life discoveries, such as a vehicle shop related to the vehicle, food and drink, and a platform related to social lives, and in addition, the system provides location based classification query. In addition, the hand ring is responsible for communicating with the in-vehicle information detection apparatus by using the Bluetooth, thereby resolving an alarm when the user is around the vehicle, reducing a false alarm rate, and improving user experience.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. An intelligent security system, wherein the system comprises an in-vehicle information detection apparatus, a network server, and a smartphone, wherein the in-vehicle information detection apparatus comprises an information transceiving module, a GPS module, and a microprocessor, wherein the GPS module sends instant location information to the microprocessor; the microprocessor performs initial processing on the received positioning information and sends the processed information to the transceiving module; the transceiving module sends received external instruction information to the microprocessor; the in-vehicle information detection apparatus sends collected instant vehicle information to the network server; the network server sends processed instant vehicle information to the smartphone by using a signal; the smartphone sends a control signal that is fed back by the mobile phone, to the network server; the network server sends the control signal to the in-vehicle information detection apparatus; the smartphone sends an anti-theft enabling signal to the in-vehicle information detection apparatus; and the smartphone receives a detection signal of the in-vehicle information detection apparatus.

2. The intelligent security system according to claim 1, wherein the system has an unlocking apparatus, the unlocking apparatus sends an unlocking signal to the in-vehicle information detection apparatus, and the unlocking apparatus receives the detection signal of the in-vehicle information detection apparatus.

3. The intelligent security system according to claim 2, wherein the unlocking apparatus comprises a communications module, an authentication module, and an information exchange module, wherein the communications module transfers the detection signal to the authentication module; the authentication module performs identity authentication according to the received detection signal and sends an authentication signal to the information exchange module; and the information exchange module converts the received authentication signal to an information exchange signal and transfers the information exchange signal to the communications module.

4. The intelligent security system according to claim 3, wherein the communications module is a Bluetooth.

5. The intelligent security system according to claim 3, wherein the communications module is a 2.4G module.

6. The intelligent security system according to claim 1, wherein there is at least one smartphone.
